(19) United States
(12) Patent Application Publication
(10) Pub. No.: US 2018/0224013 A1
(43) Pub. Date: Aug. 9, 2018

(54) DRAIN VALVE AND CONNECTING STRUCTURE

(71) Applicant: DENSO International America, Inc., Southfield, MI (US)

(72) Inventors: Sara SERES, Waterford, MI (US); Parker FARLOW, Warren, MI (US); Hugo MARTINEZ, Birmingham, MI (US); Peter MICKLEY, Farmington Hills, MI (US); Daniel TYLUTKI, Livonia, MI (US); Nikolai AKININ, West Canton, MI (US)

(21) Appl. No.: 15/428,538

(22) Filed: Feb. 9, 2017

(51) Int. Cl. F16K 27/02; F28F 9/12

(52) U.S. Cl. CPC F16K 27/02; F28F 2265/06; F28F 9/12

(57) ABSTRACT

The present disclosure provides a drain valve for a heat exchanger. The drain valve includes a plug body and a locking member. The plug body extends in an axial direction and is configured to be inserted into a discharge port of the heat exchanger. The locking member is spaced away from the plug body in a radial direction of the plug body. The locking member is configured to engage with the discharge port when the plug body is inserted into the discharge port.

### TECHNICAL FIELD

The present disclosure relates to a drain valve for a heat exchanger. The present disclosure further relates to a connecting structure for a heat exchanger.

### BACKGROUND

Conventionally, a drain valve is connected to a tank of a heat exchanger by, for example, screwing the drain valve into a discharge port disposed in the tank. To drain fluid accumulated in the tank or to vent the tank, the drain valve may be unscrewed by a user. By unscrewing the drain valve, the drain valve may be easily detached from the tank. Therefore, it has been concerned that the drain valve may be lost once the drain valve is removed from the tank.

### SUMMARY

The present disclosure addresses the above-described concerns.

According to a first aspect of the present disclosure, a drain valve for a heat exchanger including a plug body and a locking member. The plug body extends in an axial direction and is configured to be inserted into a discharge port of the heat exchanger. The locking member is spaced away from the plug body in a radial direction of the plug body. The locking member is configured to engage with the discharge port when the plug is inserted into the discharge port.

According to a second aspect of the present disclosure, a connecting structure for a heat exchanger including a discharge port and a drain valve. The drain valve is connected to the discharge port. The drain valve includes a plug body and a locking member. The plug body extends in an axial direction and is configured to be inserted into the discharge port. The locking member is spaced away from the plug body in a radial direction of the plug body. The locking member is configured to engage with the discharge port when the plug is inserted into the discharge port.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating a connecting structure according to a first embodiment in a state where a drain valve is separated from a discharge port;

FIG. 2 is a diagram illustrating the connecting structure in a state where the drain valve is connected to the discharge port;

FIG. 3 is a diagram illustrating the connecting structure according to a second embodiment in a state where the drain valve is separated from the discharge port; and

FIG. 4 is a diagram illustrating the connecting structure according to a third embodiment in a state where the drain valve is separated from the discharge port.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts may be combined. The embodiments may be partially combined even if it is not explicitly described that the embodiments may be combined, provided there is no harm in the combination.

In the following embodiments, a drain valve and a connecting structure of the present disclosure are applied to a heat exchanger that is installed to a vehicle. More specifically, the drain valve and the connecting structure are applied to a radiator installed into an engine compartment in a vehicle. However, the present disclosure can be applied to other heat exchangers that are installed to a vehicle or other machines or systems.

### First Embodiment

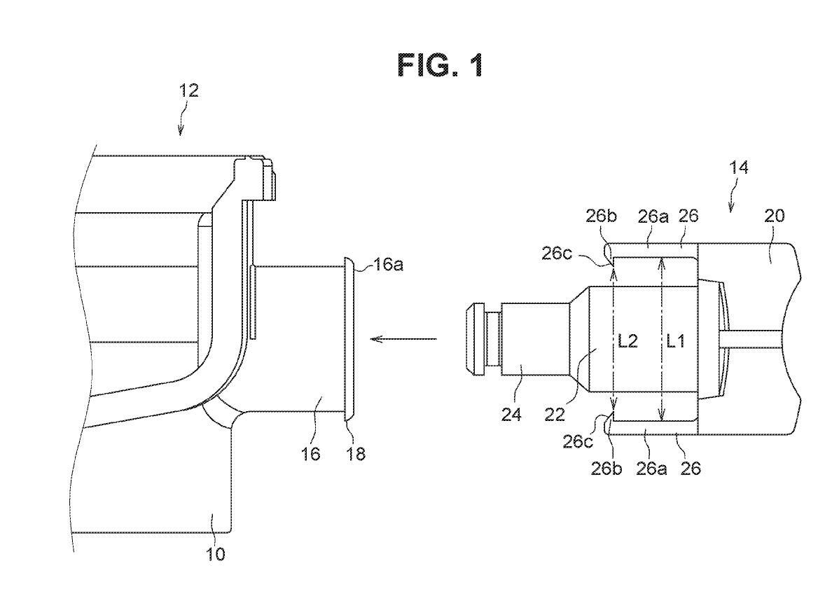

As follows, a first embodiment of the present disclosure will be described with reference to drawings. FIG. 1 illustrates a portion of a tank 10 of a radiator 12 and a drain valve 14 in a state where the drain valve 14 is separated from the tank 10. In the present embodiment, the drain valve 14 can provide two different functions, i.e., serve as a fluid discharging valve and an air bleeding valve. The tank 10 is disposed on, for example, an upper side of the core (not shown) of the radiator 12. The tank 10 is formed of plastic and includes a discharge port 16 at, for example, one end side of the tank 10. The discharge port 16 is formed into a cylindrical shape and defines an opening 16a. A fluid such as a drain water or air inside the tank 10 can be discharged through the opening 16a. It should be noted that a drain is usually discharged through a small hole (not shown) formed in the tank 10. The discharge port 16 has an inner wall that is threaded (herein after referred to as a threaded inner wall).

The discharge port 16 includes a flange 18 at one end side of the discharge port 16. The flange 18 is configured to protrude radially outward of the discharge port 16 from the outer wall thereof. Thus, the flange 18 is arranged to surround the opening 16a of the discharge port 16.

The drain valve 14 is formed of, e.g., plastic and is configured to be connected to the discharge port 16. The drain valve 14 generally includes a knob 20, a stem 22, a plug body 24, and a plurality of locking members 26. The knob 20 is used by being rotated by a user when the drain valve 14 is connected to the discharge port 16. That is, the knob 20 serves as a handle. The knob 20 includes one side surface having a circular shape.

The stem 22 extends from the one side surface of the knob 20 in a columnar shape. The radius of the stem 22 is less than that of the one side surface of the knob 20. Further, the radius of the stem 22 is slightly less than that of the opening 16a of the discharge port 16. Therefore, the stem 22 can be inserted into the discharge port 16. The stem 22 has an outer surface that is threaded (hereinafter, referred to as a threaded outer surface). The threaded outer surface is configured to be enagageable with the threaded inner surface of the discharge port 16 when the stem 22 is inserted into the discharge port 16.

The plug body 24 is configured to protrude from one end surface of the stem 22 along the axial direction. The plug body 24 has a radius less than that of the opening 16a of the discharge port 16 so that the plug body 24 can be inserted into the discharge port 16.

The locking members 26 are integrally formed with the knob 20. More specifically, the locking members 26 are integrally molded with the knob 20 (i.e., the drain valve 14). In the present embodiment, two locking members 26 are formed to be opposite to each other across the stem 22. In other words, the two locking members 26 are arranged in a circumferential direction of the drain valve 14 at regular intervals (i.e., 180 degrees).

Each of the locking members 26 includes a flexible portion 26a and a protrusion 26b. The flexible portion 26a extends along the axial direction from the one side surface of the knob 20. Thus, each of the locking members 26 has one end connected to the knob 20 and the other end that forms an open end. In other words, the locking member 26 has a cantilever shape. Each of the flexible portions 26a extends in parallel with the stem 22 and is spaced away from the stem 22 (the plug body 24) in a radial direction of the drain valve 14.

The flexible portion 26a is configured to be elastically flexible in a radial direction of the drain valve 14. As shown in FIG. 1, the distance L1 between the two locking members 26 is greater than the outer radius of the flange 18.

Each of the protrusions 26b is formed at the open end of the flexible portion 26a. The protrusion 26b protrudes from the flexible portion 26a radially inward of the drain valve 14. More specifically, each of the protrusions 26b protrudes toward each other from the flexible portion 26a. The distance L2 between the tip ends of the two protrusions 26b is less than the outer radius of the flange 18.

As shown in FIG. 1, the protrusion 26b has a substantially triangular cross-section. More specifically, the protrusion 26b has a flat surface 26c that is inclined toward the knob 20 from the open end of the flexible portion 26a to the tip end of the protrusion 26b. The flat surface 26c serves as a guide surface as described below.

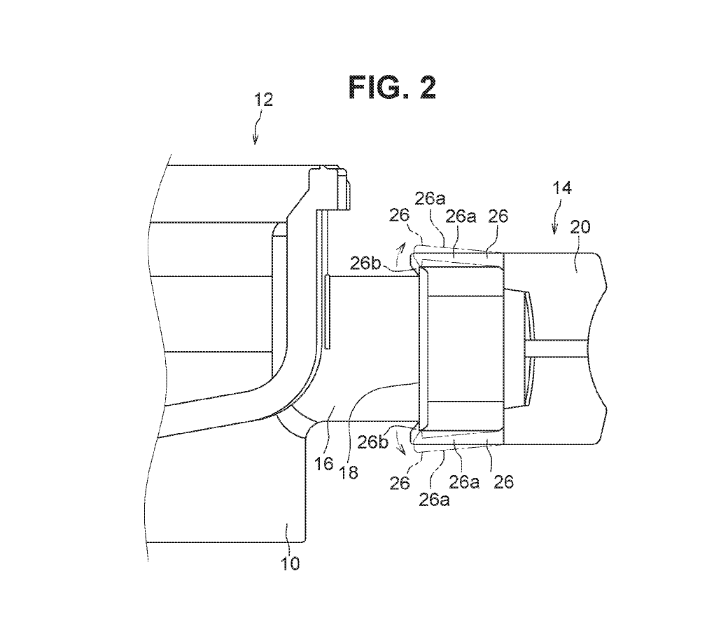

When the drain valve 14 is attached to the discharge port 16, the plug body 24 is inserted into the discharge port 16, and then the knob 20 is rotated by a user. The threaded outer surface of the stem 22 engages with the threaded inner surface of the discharge port 16. When the protrusions 26b reach the flange 18, the flat surface 26c of each of the protrusions 26b is brought into contact with the flange 18. Then, the flexible portion 26a is flexed radially outward while the flat surface 26c slides on the flange 18, as shown by the one-dot lines in FIG. 2. That is, the two flexible portions 26a are so bent as to separate from each other. As a result, the plug body 24 is allowed to be inserted into the discharge port 16 substantially without interference of the locking members 26 with the flange 18.

When the plug body 24 is further inserted into the discharge port 16, the protrusions 26b come over the flange 18 and then the flexible portions 26a elastically return back to the original position, as shown in FIG. 2. As a result, the protrusions 26b (the locking members 26) engage with the flange 18. In this way, the locking members 26 engage with the flange 18 when the plug body 24 is inserted into the discharge port 16. Due to the engagement between the locking members 26 and the flange 18, the drain valve 14 is prevented from being removed from the discharge port 16.

Furthermore, the two locking members 26 are arranged to be opposite to each other (i.e., at 180 degrees). Therefore, the two locking members 26 can engage with the flange 18 by clamping the flange 18 therebetween, whereby each of the locking members 26 can properly engage with the flange 18.

### Second Embodiment

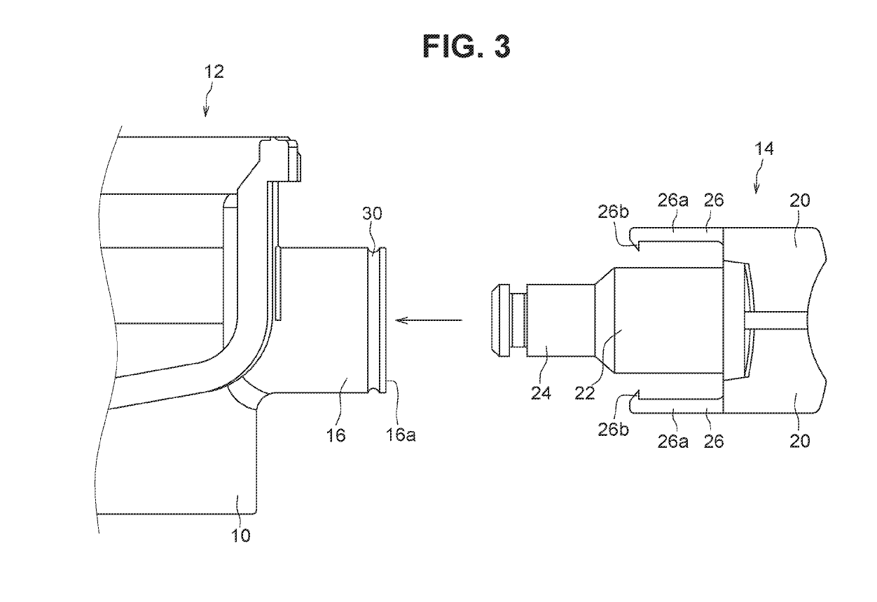

In the first embodiment, the discharge port 16 includes the flange 18 that is engaged with the locking members 26. In the second embodiment, the discharge port 16 includes a groove 30 formed on the outer wall thereof, as shown in FIG. 3. The groove 30 is recessed from the outer wall of the discharge port 16 in an annular shape. In this embodiment, the protrusions 26b engage with the groove 30 when the plug body 24 is inserted into the discharge port 16 by being fit into the groove 30. Accordingly, as with the first embodiment, the drain valve 14 is prevented from being removed from the discharge port 16 because of the engagement between the locking members 26 and the groove 30.

### Third Embodiment

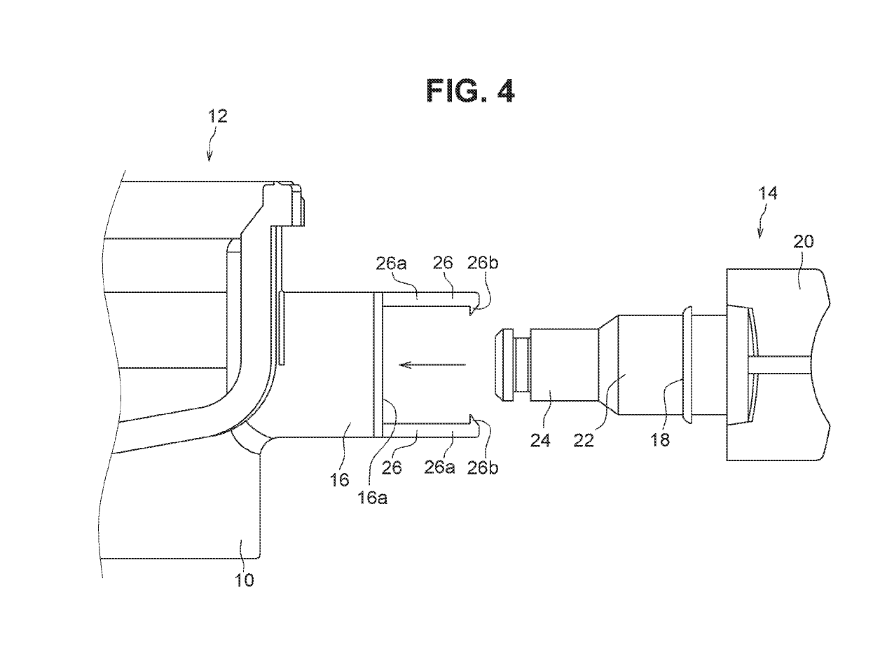

In the above-described embodiments, the locking members 26 is formed in the drain valve 14. Alternatively, the locking members 26 may be formed in the discharge port 16 as shown in FIG. 4. In this embodiment, the locking members 26 are formed to extend toward the drain valve 14 from the opening 16a. Other configurations of the locking members 26 are same as the first embodiment. The flange 18 is formed circumferentially around the stem 22 of the drain valve 14. The flange 18 radially protrudes from the stem 22.

When the drain valve 14 is connected to the discharge port 16, the locking members 26 engage with the flange 18. Therefore, as with the first embodiment, the drain valve 14 is prevented from being removed from the discharge port 16.

### Other Embodiments

In the above-described embodiment, the locking member is integrally formed with the knob 20. However, the locking member may be formed in, for example, the stem 22. Furthermore, the locking member may be not necessarily formed with the drain valve 14 in an integral form. In other words, the locking member may be formed of a material different from the material of the drain valve 14.

In the above-described embodiment, the locking member 26 includes the protrusions 26b, and the protrusions 26b engage with the flange 18 when the plug body 24 is inserted into the discharge port 16. Alternatively, the locking member 26 may include recessed portions, and the flange 18 may engage with the recessed portions by being fit into the recessed portions.

In the above-described embodiment, the two locking members 26 are formed with 180 degrees intervals. However, the intervals between the two locking members 26 may be any degrees other than 180 degrees. Furthermore, three or more of the locking members 26 may be formed in the drain valve 14 in the circumferential direction at regular intervals. In this case, the angle between two neighboring locking members 26 may be less than 180 degrees.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. As used herein, the term “and/or” includes any and all combinations of one or more of the associated listed items.

1-8. (canceled)

9. A connecting structure for a heat exchanger, the connecting structure comprising:
a discharge port of the heat exchanger; and
a drain valve that is configured to be connected to the discharge port, wherein
the drain valve includes
a plug body that extends in an axial direction and is configured to be inserted into the discharge port along an insertion direction, and
a locking member that is spaced away from the plug body in a radial direction of the plug body, and
the locking member is configured to engage with the discharge port when the plug body is inserted into the discharge port,
the locking member includes a flexible portion that extends along the axial direction of the plug body and is configured to be elastically flexible,
the flexible portion allows the plug body to be inserted into the discharge port by flexing radially outward when the plug body is inserted into the discharge port,
the locking member includes a protrusion that protrudes radially inward from the flexible portion,
the discharge port includes a flange formed on an outer wall of the discharge port, and
the protrusion is configured to engage with the flange when the plug body is inserted into the discharge port, wherein
the protrusion includes a flat surface that gradually outwardly inclines in the insertion direction, and
the flange includes a guiding surface that gradually outwardly inclines in the insertion direction.

10-12. (canceled)

13. The connecting structure according to claim 9, wherein
the locking member is one of a plurality of locking members.

14. The connecting structure according to claim 13, wherein
the plurality of locking members are arranged in a circumferential direction at regular intervals.

15. The connecting structure according to claim 9, wherein
the discharge port has a threaded inner surface, and
the drain valve further includes:
a stem that is connected to the plug body, the stem having a threaded outer surface that is engageable with the threaded inner surface of the discharge port; and
a knob that is rotated by a user when the plug body is inserted into the discharge port, wherein
the locking member is configured to have a cantilever shape protruding from the knob.

16. The connecting structure according to claim 15, wherein
the locking member is integrally formed with the knob.

17. A connecting structure for a heat exchanger, the connecting structure comprising:
a discharge port of the heat exchanger; and
a drain valve that is configured to be connected to the discharge port, wherein
the drain valve includes a plug body that extends in an axial direction and is configured to be inserted into the discharge port along an insertion direction,
the discharge port includes a locking member that extends towards the drain valve, and
the locking member is configured to engage with the drain valve when the plug body is inserted into the discharge port,
the drain valve further includes:
a stem that is coaxially connected to the plug body; and
a flange that is formed around the stem to radially protrude from the stem, and
the locking member is configured to engage with the flange when the plug body is inserted into the discharge port, wherein
the locking member includes a protrusion that protrudes radially inward from the flexible portion,
the protrusion includes a flat surface that gradually inwardly declines in the insertion direction, and
the flange includes a guiding surface that gradually inwardly declines in the insertion direction.

18. (canceled)
